(19) United States
(12) Patent Application Publication
(10) Pub. No.: US 2020/0065868 A1
(43) Pub. Date: Feb. 27, 2020

(54) SYSTEMS AND METHODS FOR ANALYZING CUSTOMER FEEDBACK

(71) Applicant: Walmart Apollo, LLC, Bentonville, AR (US)

(72) Inventors: Mani Kanteswara Rao Garlapati, Bangalore (IN); Bharadwaj Aldur Siddegowda, Bangalore (IN); Keshav Sehgal, Bangalore (IN)

(21) Appl. No.: 16/549,142

(22) Filed: Aug. 23, 2019

Related U.S. Application Data
(60) Provisional application No. 62/746,133, filed on Oct. 16, 2018.

(30) Foreign Application Priority Data
Aug. 23, 2018 (IN) 201841031541

(51) Int. Cl. G06Q 30/02; G06F 16/2457; G06F 3/16; G06F 17/27; G10L 15/26

(52) U.S. Cl. CPC G06Q 30/0282; G06F 16/24578; G10L 15/265; G06F 17/2705; G06F 17/2735; G06F 3/16

(57) ABSTRACT

In some embodiments, apparatuses and methods are provided herein useful to analyzing and presenting data associated with customer feedback. In some embodiments, a system comprises a display device configured to present a GUI, a database configured to receive and store the customer feedback, and a control circuit including a feedback parsing module configured to retrieve a review for a product, break the review for the product into segments, a sentiment calculation module configured to assign tags associated with aspects of the product to the segments, calculate a sentiment score for each of the segments, and normalize the sentiment score for each of the segments, an aspect weighted rating module configured to calculate an aspect weighted rating for each of the aspects, wherein the aspect weighted rating for each of the aspects represents an importance of each of the aspects, and a presentation module configured to generate the GUI.

### TECHNICAL FIELD

This invention relates generally to customer feedback and, more particularly, to analyzing customer feedback.

### BACKGROUND

Many retailers, especially those that provide an online shopping portal, allow customers to provide customer feedback. The feedback can be in the form of a rating (e.g., on a scale) or written text. This customer feedback is valuable not only to customers (e.g., to aid in making purchasing decisions), but also to retailers. For example, retailers may attempt to use customer feedback to better understand customers' purchases and impressions of products. While reviewing the customer feedback can provide retailers with insight into the customers' experiences, the volume of customer feedback available can make this review tedious and limit its value. Consequently, systems, methods, and apparatuses are needed to aid in analyzing customer feedback and generating interfaces through which data regarding the customer feedback can be viewed.

### BRIEF DESCRIPTION OF THE DRAWINGS

Disclosed herein are embodiments of systems, apparatuses and methods pertaining to analyzing and presenting data associated with customer feedback. This description includes drawings, wherein:

FIG. 1 depicts a graphical user interface (GUI) 100 including an overall rating for a review 124 and aspect weighted ratings 116 for each of the aspects, according to some embodiments;

FIG. 2 is a block diagram of a system 200 for analyzing and presenting data associated with customer feedback, according to some embodiments; and

FIG. 3 is a flow chart including example operations for analyzing and presenting data associated with customer feedback, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to analyzing and presenting data associated with customer feedback. In some embodiments, a system for analyzing and presenting data associated with customer feedback comprises a display device, wherein the display device is configured to present a graphical user interface (GUI), a database, wherein the database is configured to receive, from a server, the customer feedback, and store the customer feedback, and a control circuit, wherein the control circuit is configured to analyze the data associated with the customer feedback, and wherein the control circuit includes a feedback parsing module, wherein the feedback parsing module is configured to retrieve, from the database, a review for a product, and break, based on a delimiter, the review for the product into one or more segments, a sentiment calculation module, wherein the sentiment calculation module is configured to assign, to each of the one or more segments based on a word database, tags, wherein the tags are based on words included in each of the one or more segments, and wherein the tags are associated with aspects for the product, calculate, based on a sentiment algorithm, a sentiment score for each of the one or more segments, and normalize the sentiment score for each of the one or more segments, an aspect weighted rating module, wherein the aspect weighted rating module is configured to calculate, based on an overall rating for the review and the normalized sentiment scores for each of the one or more segments, an aspect weighted rating for each of the aspects, wherein the aspect weighted rating for each of the aspects represents an importance of each of the aspects to the overall rating for the review, and a presentation module, the presentation module configured to generate, for presentation via the display device, the GUI, wherein the GUI includes at least the overall rating for the review and the aspect weighted rating for each of the aspects.

As previously discussed, many retailers allow customers to provide feedback regarding products (i.e., in the form of customer reviews). These customer reviews are typically limited to a rating scale and/or textual/speech input. Retailers attempt to use this information to better understand customer impressions of products and purchasing decisions. However, the amount of information that can be gleaned by simply aggregating reviews is limited. For example, if 100 customers rated a product, a retailer will use the 100 ratings to calculate an average rating for the product. Although the average rating for the product may have some value, it doesn't provide information specific to different qualities of the product and/or why a customer ultimately did, or did not, purchase a product.

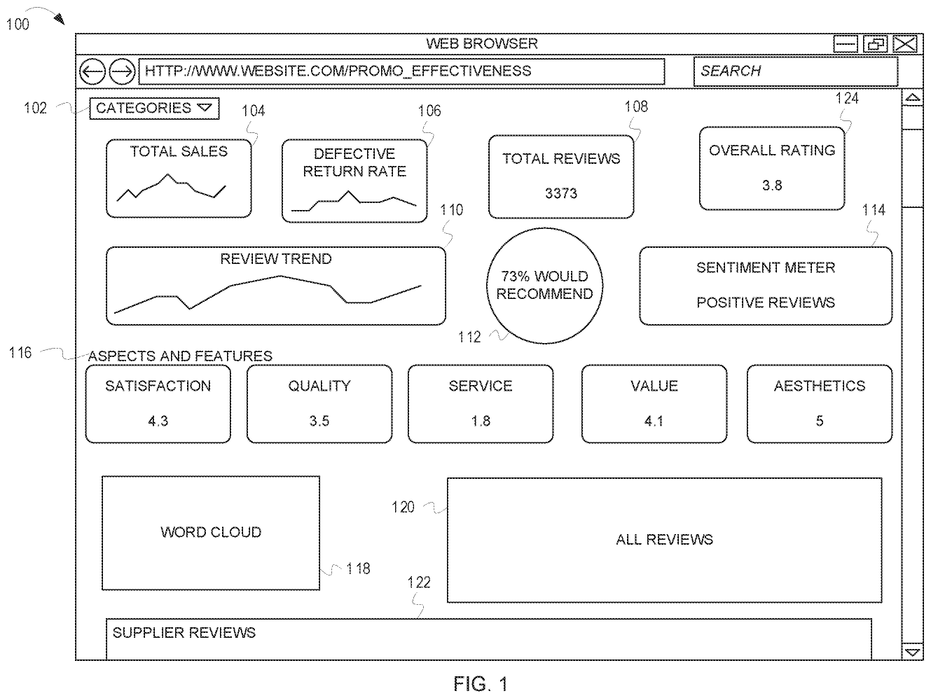

In some embodiments, as described herein, systems, methods, and apparatuses analyze customer feedback and present data associated with the customer feedback that goes deeper than simply aggregating reviews or determining an average rating for a product. In some embodiments, a system will analyze the review to determine what aspects of the product impacted the overall rating for a product. For example, a customer review may include a rating (e.g., 4 stars) and a textual portion (e.g., either textual input or spoken input). If the textual portion references the quality of the product, the price of the product, and the aesthetics of the product, the system analyzes the textual portion of the customer review with respect to the overall rating to determine the importance of each of the aspects (i.e., the quality, price, and aesthetics of the product) on the overall rating. The system analyzes the sentiment of the customer toward each of the aspects, assigns a rating to each of the aspects, then calculates weights for each of the aspects (i.e., aspect weighted ratings). The system uses the aspect weighted ratings and the overall rating for the review to determine the importance of each aspect on the overall rating (i.e., to what degree each aspect impacts the overall rating). The system generates a graphical user interface (GUI) that includes the overall rating for the review and the aspect weighted ratings. The discussion of FIG. 1 describes an overview of an example GUI.

FIG. 1 depicts a graphical user interface (GUI) 100 including an overall rating for a review 124 and aspect weighted ratings 116 for each of the aspects, according to some embodiments. As depicted in FIG. 1, the aspects include a “satisfaction” aspect, a “quality” aspect, a “service” aspect, a “value” aspect, and an “aesthetics” aspect. While FIG. 1 provides several example aspects, embodiments are not limited to these enumerated aspects. That is, any relevant aspects of a product can be examined. In addition to the overall rating for the review 124 and the aspect weighted ratings 116 for each of the aspects, the GUI 100 can include any other suitable or desired information. For example, as depicted in FIG. 1, the GUI 100 includes total sales data 104, defective return rate data 106, total reviews data 108, review trend data 110, “would recommend” data 112, sentiment meter data 114, word cloud data 118, all reviews data 120, and supplier reviews data 122. Additionally, the GUI 100 can include selections, such as selection 102 that allows a user to manipulate the data and/or change which data is presented. The GUI 100 can be presented in any suitable manner. For example, the GUI 100 can be generated by, and presented via, a computing device (i.e., in a thick-client example) or presented via a browser (i.e., in a thin-client example) as depicted in FIG. 1.

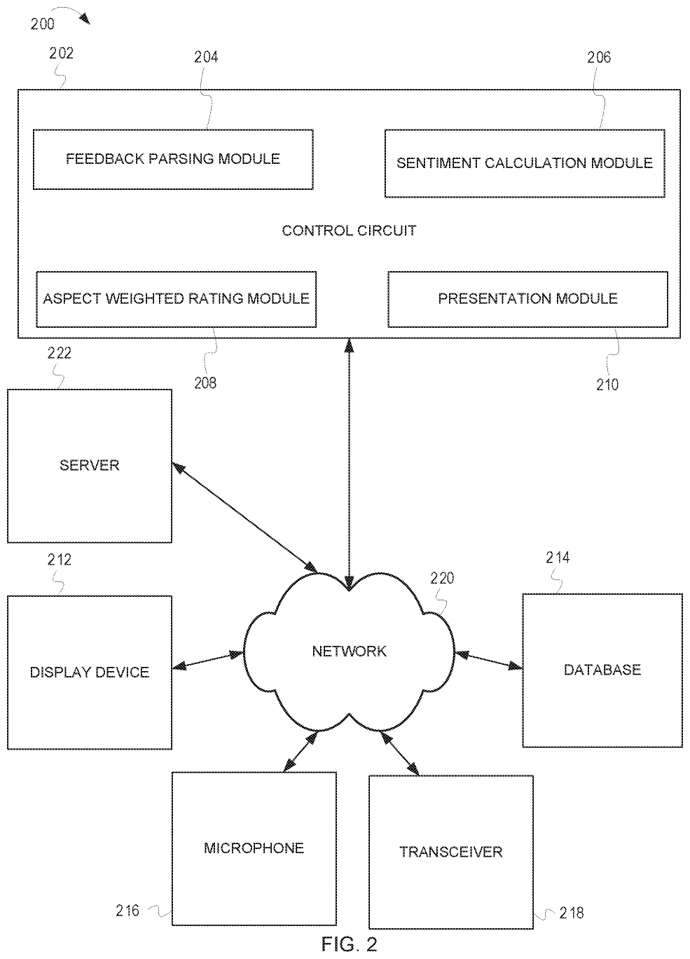

While the discussion of FIG. 1 provides an overview of a GUI for presenting data associated with customer feedback, the discussion of FIG. 2 provides greater detail regarding a system for analyzing and presenting data associated with customer feedback.

FIG. 2 is a block diagram of a system 200 for analyzing and presenting data associated with customer feedback, according to some embodiments. The system 200 includes a control circuit 202. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The system 200 also includes a display device 212, a database 214, a microphone 216, a transceiver 218, and a server 222. The control circuit 202, display device 212, database 214, microphone 216, transceiver 218, and server 222 are communicatively coupled via a network 220. The network 220 can be any suitable type of network, such as an intranet and/or an internet (e.g., the Internet). Accordingly, some, none, or all of these components can be local to and/or remote from one another. In some embodiments, the control circuit 202 is hosted on top of a HANA database and the database 214 can be a Hadoop cluster.

The display device 212 is configured to present a GUI including data associated with customer feedback. The database 214 is configured to store the customer feedback. In some embodiments, the database 214 receives the customer feedback from the server 222. For example, if the customer feedback is auditory (e.g., a spoken review of a product), the microphone 216 captures voice input (including the customer feedback) from the customer and the transceiver 218 transmits the voice input to the server 222. In embodiments in which customer feedback is voice input, the server 222 converts the customer feedback to text and transmits the textual customer feedback to the database 214 for storage.

In some embodiments, the control circuit 202 includes one or more modules. In such embodiments, the modules perform tasks. For example, as depicted in FIG. 2, the control circuit 202 includes a feedback parsing module 206, a sentiment calculation module 206, an aspect weighted rating module 208, and a presentation module 210.

The feedback parsing module 206 is responsible for organizing customer feedback. For example, the feedback parsing module 206 retrieves, from the database 214, reviews for products. After retrieving a review, the feedback parsing module 206 parses the review to break the review into segments. In some embodiments, the feedback parsing module 206 parses the review based on a delimiter (e.g., a period, a comma, a pause, certain words (e.g., and, or, but, etc.), etc.). For example, if the review includes the sentences “The picture quality of the TV is good.” and “The audio quality is not as good as I'd like.” the feedback parsing module 206 can break the review into two segments (i.e., 1) “The picture quality of the TV is good” and 2) “The audio quality is not as good as I'd like”).

The sentiment calculation module 206 is responsible for determining to which aspects the segments refer, calculating sentiment scores for the segments, and normalizing sentiment scores associated with the segments. As previously discussed, a product can have a number of aspects (e.g., the quality of the product, the price of the product, the aesthetics of the product, the size of the product, the weight of the product, the product's ability to perform a task, etc.). The reviews describe the products in terms of the aspects. Continuing the example above, the two-sentence review describes the picture quality and audio quality of a television. The picture quality of the television and the audio quality of the television are aspects of the television. The sentiment calculation module 206 determines to what aspects the review refers based on a word database. In some embodiments, the word database includes a mapping and a dictionary. The dictionary includes a list of words the refer to aspects, and the mapping associates the words with the aspects (i.e., links the words to the aspects). For example, the dictionary may include the words “picture,” “video,” “image,” and “color.” The words “picture,” “video,” “image,” and “color” may refer to the picture quality aspect of a television. The mapping would associate each of these words with the aspect “picture quality.” In the two-sentence review example provided above, the first sentence (i.e., “The picture quality is good”) would refer to the “picture quality” aspect and the second sentence (i.e., “The audio quality is not as good as I'd like”) refers to the “audio quality” aspect. The sentiment calculation module 206 determines these references based on the word database and assigns tags to the sentences. For example, the sentiment calculation module would assign the tag “picture quality” to the first sentence and the tag “audio quality” to the second sentence.

After assigning the tag to the segments, the sentiment calculation module 206 calculates a sentiment scores for each of the segments. In some embodiments, the sentiment calculation module 206 calculates the sentiment scores for the segments based on a sentiment algorithm, such as a valence aware dictionary and sentiment reasoner (VADER) analysis tool. In such embodiments, the sentiment scores have a numeric value. For example, the numeric value can range from −1 (i.e., negative one) to 1 (i.e., one), where −1 reflects a strong negative sentiment for the segment and 1 reflects a strong positive sentiment for the segment. In some embodiments, the sentiment calculation module 206 normalizes the sentiment scores. That is, if the sentiment scores conform to a range, the sentiment calculation module 206 can normalize the scores to a new or different range. For example, if the sentiment scores range from −1 to 1, the sentiment calculation module can normalize the sentiment scores to a five-star scale. One manner of doing so is by multiplying the sentiment scores for each of the one or more segments by two and adding three (i.e., Normalized Score=Sentiment Score×2+3). The results of the sentiment calculation module's 206 responsibilities are normalized sentiment scores for each of the segments. In the two-sentence review provided above, the sentiment score of the first sentence may be 0.6 and the sentiment score for the second sentence may be −0.3 for example, as determined by a sentiment algorithm. Accordingly, the sentiment calculation module 206 will assign the “picture quality” tag to the first sentence and calculate a normalized sentiment score of the first sentence as 4.2 and assign the “audio quality” to the second sentence and calculate a normalized sentiment score of the second sentence as 2.4.

The aspect weighted rating module 208 is responsible for determining the impact of the each of the aspects on the overall rating for the review. In some embodiments, the aspect weighted rating module 208 calculates aspect weighted ratings for each of the aspects. From a mathematical perspective, this calculation can be thought of based on the following formula:

Rating=Score₁×Aspect Weighted Rating₁+ . . . +Score_{N}×Aspect Weighted Rating_{N}

where, “Rating” is the overall rating for the product, “Score₁” is the normalized sentiment score for the first aspect, “Aspect Weighted Rating₁” is the aspect weighed rating for the first aspect, “Score_{N}” is the normalized sentiment score for the N^{th} aspect, and “Aspect Weighted Rating_{N}” is the aspect weighed rating for the N^{th} aspect. Continuing the two-sentence review example provided above, the aspect weighted rating module 208 would calculate aspect weighted ratings for the “picture quality” and “audio quality” aspects. In mathematical terms, this would be expressed as:

Rating=Picture Score×Picture Weight Rating+Audio Score×Audio Weight Rating

That is, the aspect weighted rating module 208 uses the normalized sentiment scores to determine how important each of the aspects is to the overall rating. Assuming the overall rating for the two-sentence review is 3.5 and the calculated normalized sentiment scores are 4.2 for the first sentence (i.e., the “picture quality” aspect) and 2.4 for the second sentence (i.e., the “audio quality” aspect), the equation would be:

3.5=4.2×A+2.4×B

where A is the aspect weighted rating for the “picture quality” aspect and B is the aspect weighted ratings for the “audio quality” aspect. The values of A and B represent the importance of the “picture quality” aspect and the “audio quality” aspect, respectively, on the overall review. In one embodiment, the aspect weighted rating module 208 calculates the importance of each of the aspects on the overall rating based on an algorithm, such as an L-BFGS algorithm. A constraint of the L-BFGS algorithm is that the sum of all of the aspect weighted ratings (i.e., A and B in the example above) must equal one. Using an algorithm with such a constraint, the aspect weighted ratings for the “picture quality” aspect and the “audio quality” aspect would be 0.6 and 0.4, respectively. That is,

3.5=4.2×0.6+2.4×0.4.

The aspect weighted ratings for the “picture quality” aspect and the “audio quality” aspects in this example would indicate that the “picture quality” aspect is one and half times as important to the customer as the “audio quality” aspect (i.e., the “picture quality” aspect weighted rating of 0.6 is one and a half times 0.4, the aspect weighted rating for the “audio quality” aspect).

The presentation module 210 is configured to generate the GUI. As previously discussed, the GUI can include any suitable and/or desired data associated with the customer feedback. In some embodiments, the GUI includes at least the overall rating for the review and the aspect weighted rating for each of the aspects.

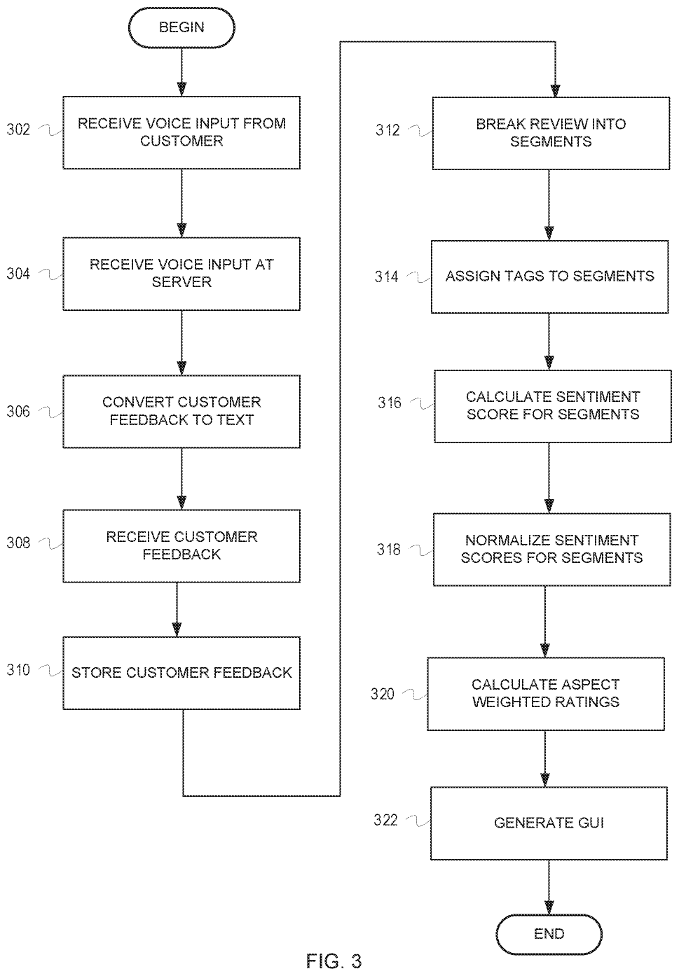

While the discussion of FIG. 2 provides additional detail regarding a system for analyzing and presenting data associated with customer feedback, the discussion of FIG. 3 provides example operations for analyzing and presenting data associated with customer feedback.

FIG. 3 is a flow chart including example operations for analyzing and presenting data associated with customer feedback, according to some embodiments. The flow begins at block 302.

At block 302, voice input is received from a customer. For example, a microphone can receive the voice input. In some embodiments, voice input is not received unless the customer provides permission for his or her voice input, and by extension his or her customer feedback, to be recorded and/or analyzed. In such embodiments, the customer may be prompted as to whether he or she gives his or her permission for the customer feedback to be published, recorded, and/or analyzed. For example, the customer may be asked explicitly if he or she give his or her permission. In embodiments in which the customer feedback is textual (e.g., a written review on a website), the customer may be presented with a “permission prompt” in which the customer can select whether or not he or she would like his or her comment to published, recorded, and/or analyzed. Further in some embodiments, the customer may be provided with notification that his or her customer feedback may be recorded, published, and/or analyzed. The microphone may be included in a telephone with which the customer is providing his or her voice input or remote from the customer. The voice input includes the customer feedback. The flow continues at block 304.

At block 304, the voice input is received at a server. For example, the voice input can be received at the server from a transceiver. The flow continues at block 306.

At block 306, the customer feedback is converted to text. For example, the server can convert the customer feedback to text. The server can convert the customer feedback to text by first extracting and/or isolating the customer feedback from the voice input then using speech-to-text conversion. In embodiments in which the customer feedback is a written review, this step can be skipped. The flow continues at block 308.

At block 308, customer feedback is received at a database and at block 310 the database stores the customer feedback. For example, the database can receive the customer feedback from the server. The database stores the customer feedback. In some embodiments, the database can store written customer feedback, textual conversion of customer feedback included in voice input, and/or voice input. The flow continues at block 312.

At block 312, a review is broken into segments. For example, a control circuit can break the review into segments. The review originates from the customer feedback. For example, the customer feedback can include a rating and a written or spoken portion (i.e., the review). The review is for a product. The control circuit breaks the review into segments based on one or more delimiters. The flow continues at block 314.

At block 314, tags are assigned to the segments. For example, the control circuit can assign tags to the segments. The tags are associated with aspects of the product. That is, the tags identify to which aspect a segment refers. The control circuit assigns tags based on a word database. For example, the control circuit matches words included in the review with those in the word database and assigns the tags based on the words. The flow continues at block 316.

At block 316, sentiment scores for the segments are calculated. For example, the control circuit can calculate the sentiment scores for the segments. The sentiment scores for the segments reflect the customer's sentiment toward each aspect. For example, if a segment is associated with a “value” aspect of a product (i.e., the segment is assigned the “value” aspect tag), the control circuit calculates the customer's sentiment to the “value” aspect of the product of that segment. In some embodiments, the control circuit calculates the sentiment scores for the segments based on a sentiment algorithm. Additionally, or alternatively, the control circuit can calculate sentiment scores based on the occurrence of positive and/or negative adjectives in the segments. The flow continues at block 318.

At block 318, the sentiment scores for the segments are normalized. For example, the control circuit can normalize the sentiment scores for the segments. That is, the control circuit can convert the sentiment scores to a scale. For example, the control circuit can convert the sentiment scores to a five-star scale, or any other suitable scale. The flow continues at block 320.

At block 320, aspect weighted ratings are calculated. For example, the control circuit can calculate the aspect weighted ratings. The aspect weighted ratings are based on an overall rating for the review and the normalized sentiment scores for each of the segments. The aspect weighted rating represents an importance of an aspect to the overall rating for the review. For example, if a rating discusses three aspects (e.g., a “price” aspect, an “aesthetic” aspect, and a “size” aspect) of a product, the aspect weighted rating for each of those three aspects represent how important each aspect is to the overall rating. If the normalized sentiment score for the “price” aspect is a 5, the normalized sentiment score for the “aesthetic” aspect is a 1, the normalized sentiment score for the “size” aspect is a 1, and the overall rating for the product is a 4.5, it may indicate that the “price” aspect of the product was much more important to the customer than either the “aesthetic” aspect or the “size” aspect. The flow continues at block 322.

At block 322, a GUI is generated. For example, the control circuit can generate the GUI. The GUI includes at least the overall rating for the product and the aspect weighted ratings for each of the aspects. The GUI is presented by a display device.

In some embodiments, a system for analyzing and presenting data associated with customer feedback comprises a display device, wherein the display device is configured to present a graphical user interface (GUI), a database, wherein the database is configured to receive, from a server, the customer feedback, and store the customer feedback, and a control circuit, wherein the control circuit is configured to analyze the data associated with the customer feedback, and wherein the control circuit includes a feedback parsing module, wherein the feedback parsing module is configured to retrieve, from the database, a review for a product, and break, based on a delimiter, the review for the product into one or more segments, a sentiment calculation module, wherein the sentiment calculation module is configured to assign, to each of the one or more segments based on a word database, tags, wherein the tags are based on words included in each of the one or more segments, and wherein the tags are associated with aspects for the product, calculate, based on a sentiment algorithm, a sentiment score for each of the one or more segments, and normalize the sentiment score for each of the one or more segments, an aspect weighted rating module, wherein the aspect weighted rating module is configured to calculate, based on an overall rating for the review and the normalized sentiment scores for each of the one or more segments, an aspect weighted rating for each of the aspects, wherein the aspect weighted rating for each of the aspects represents an importance of each of the aspects to the overall rating for the review, and a presentation module, the presentation module configured to generate, for presentation via the display device, the GUI, wherein the GUI includes at least the overall rating for the review and the aspect weighted rating for each of the aspects.

In some embodiments, an apparatus and a corresponding method performed by the apparatus comprises receiving, at a database from a server, the customer feedback, storing, in the database, the customer feedback, breaking, by a feedback parsing module based on a delimiter, a review into one or more segments, assigning, by a sentiment calculation module to each of the one or more segments based on a word database, tags, wherein the tags are based on words included in each of the one or more segments, and wherein the tags are associated with aspects for the product, calculating, by the sentiment calculation module based on a sentiment algorithm, a sentiment score for each of the one or more segments, normalizing, by the sentiment calculation module, the sentiment score for each of the one or more segments, calculating, by an aspect weighted rating module based on an overall rating for the review and the normalized sentiment scores for each of the one or more segments, an aspect weighted rating for each of the aspects, wherein the aspect weighted rating for each of the aspects represents an importance of each of the aspects to the overall rating for the review, generating, by a presentation module for presentation via a display device, a graphical user interface (GUI), wherein the GUI includes at least the overall rating for the review and the aspect weighted rating for each of the aspects, and presenting, via the display device, the GUI.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for analyzing and presenting data associated with customer feedback, the system comprising:
a display device, wherein the display device is configured to present a graphical user interface (GUI);
a microphone, wherein the microphone is configured to capture voice input from a customer, wherein the voice input includes the customer feedback, and wherein the microphone is remote from the customer;
a transceiver, wherein the transceiver is configured to transmit, to a server, the voice input;
the server, wherein the server is configured to receive, from the transceiver, the voice input and convert the customer feedback to text;
a database, wherein the database is configured to:
receive, from the server, the customer feedback; and
store the customer feedback; and
a control circuit, wherein the control circuit is configured to analyze the data associated with the customer feedback, and wherein the control circuit includes:
a feedback parsing module, wherein the feedback parsing module is configured to:
retrieve, from the database, a review for a product; and
break, based on a delimiter, the review for a product into one or more segments;
a sentiment calculation module, wherein the sentiment calculation module is configured to:
assign, to each of the one or more segments based on a word database, tags, wherein the tags are based on words included in each of the one or more segments, and wherein the tags are associated with aspects for the product;
calculate, based on a sentiment algorithm, a sentiment score for each of the one or more segments; and
normalize the sentiment score for each of the one or more segments;
an aspect weighted rating module, wherein the aspect weighted rating module is configured to:
calculate, based on an overall rating for the review and the normalized sentiment scores for each of the one or more segments, an aspect weighted rating for each of the aspects, wherein the aspect weighted rating for each of the aspects represents an importance of each of the aspects to the overall rating for the review; and
a presentation module, the presentation module configured to:
generate, for presentation via the display device, the GUI, wherein the GUI includes at least the overall rating for the review and the aspect weighted rating for each of the aspects.

2. The system of claim 1, wherein the control circuit is further configured to:
receive, from the customer, permission to capture the voice input, wherein the voice input is not captured if permission is not received.

3. The system of claim 1, wherein the sentiment algorithm is a valence aware dictionary and sentiment reasoner (VADER) analysis tool.

4. The system of claim 3, wherein the sentiment scores for each of the one or more segments range from negative one to one, and wherein the normalization of the sentiments scores for each of the one or more segments converts the sentiments scores for each of the one or more segments to a five-star scale.

5. The system of claim 1, wherein the sentiment calculation module normalizes the sentiment scores for each of the one or more segments by multiplying the sentiment scores for each of the one or more segments by two and adding three.

6. The system of claim 1, wherein the aspect weighted rating module calculates the aspect weighted ratings for each of the aspects based on an L-BFGS algorithm.

7. The system of claim 6, wherein the sum of all of the aspect weighted ratings for each of the aspects equals one.

8. The system of claim 1, wherein the word database includes a mapping and a dictionary.

9. The system of claim 8, wherein the mapping links categories and a list of aspects, and wherein the dictionary includes a set of words for each of the aspects.

10. The system of claim 1, wherein the control circuit is hosted on top of a HANA database, and wherein the database is a Hadoop cluster.

11. A method for analyzing and presenting data associated with customer feedback, the method comprising:
receiving, via a microphone from a customer, voice input, wherein the voice input includes the customer feedback, wherein the microphone is remote from the customer;
receiving, at a server from a transceiver, the voice input;
converting, by the server, the customer feedback to text;
receiving, at a database from the server, the customer feedback;
storing, in the database, the customer feedback;
breaking, by a feedback parsing module based on a delimiter, a review into one or more segments;
assigning, by a sentiment calculation module to each of the one or more segments based on a word database, tags, wherein the tags are based on words included in each of the one or more segments, and wherein the tags are associated with aspects for the product;
calculating, by the sentiment calculation module based on a sentiment algorithm, a sentiment score for each of the one or more segments;
normalizing, by the sentiment calculation module, the sentiment score for each of the one or more segments;
calculating, by an aspect weighted rating module based on an overall rating for the review and the normalized sentiment scores for each of the one or more segments, an aspect weighted rating for each of the aspects, wherein the aspect weighted rating for each of the aspects represents an importance of each of the aspects to the overall rating for the review;
generating, by a presentation module for presentation via a display device, a graphical user interface (GUI), wherein the GUI includes at least the overall rating for the review and the aspect weighted rating for each of the aspects; and
presenting, via the display device, the GUI.

12. The method of claim 11, further comprising:
receiving, from the customer, permission to capture the voice input, wherein the voice input is not captured if permission is not received.

13. The method of claim 11, wherein the sentiment algorithm is a valence aware dictionary and sentiment reasoner (VADER) analysis tool.

14. The method of claim 13, wherein the sentiment scores for each of the one or more segments range from negative one to one, and wherein the normalizing the sentiments scores for each of the one or more segments comprises converting the sentiments scores for each of the one or more segments to a five-star scale.

15. The method of claim 11, wherein the normalizing the sentiment scores for each of the one or more segments comprises multiplying the sentiment scores for each of the one or more segments by two and adding three.

16. The method of claim 11, wherein the calculating the aspect weighted ratings for each of the aspects is performed using an L-BFGS algorithm.

17. The method of claim 16, wherein the sum of all of the aspect weighted ratings for each of the aspects equals one.

18. The method of claim 11, wherein the word database includes a mapping and a dictionary.

19. The method of claim 18, wherein the mapping links categories and a list of aspects, and wherein the dictionary includes a set of words for each of the aspects.

20. The method of claim 11, wherein the control circuit is hosted on top of a HANA database, and wherein the database is a Hadoop cluster.
